(19) United States
(12) Patent Application Publication
(10) Pub. No.: US 2008/0113837 A1
(43) Pub. Date: May 15, 2008

(54) Tension or Guide Rail with an Installation Channel

(75) Inventors: Sandra Ketterl, Moosinning (DE); Michael Weikert, Neufinsing (DE); Martin Bodensteiner, Erding (DE); Henning Geibel, Gilching (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: JOH. WINKLHOFER & SOHNE GMBH UND CO. KG, Munchen (DE)

(21) Appl. No.: 10/583,021

(22) PCT Filed: Jan. 21, 2005
(86) PCT No.: PCT/EP05/00599

§ 371 Date: Jul. 27, 2007

(30) Foreign Application Priority Data
Feb. 4, 2004 (DE) 20 2004 001 679.6

(51) Int. Cl. F16H 7/18; F16H 55/36

(52) U.S. Cl. 474/140; 474/166

(57) ABSTRACT

A tension or guide rail for a flexible drive means, in particular for a timing chain of an internal combustion engine, with a carrier body and guide track which can be pressed onto the flexible drive means, where the tension or guide rail comprises an installation channel which is independent of the action of the guide track. The carrier body can comprise at least a first and at least a second carrier-body side part, which are permanently joined together and which jointly define the installation channel. Furthermore, an internal combustion engine with a timing drive comprising a flexible drive means and at least one such tension or guide rail, whereby the flexible drive means is in contact with the guide track and an additional component acting interactively with the internal combustion engine extends through the installation channel at least in some regions.

### CROSS-REFERENCE TO RELATED APPLICATION

This is the U.S. national stage under 35 U.S.C. § 371, of international application no. PCT/EP2005/000599, having an international filing date of Jan. 21, 2005, and claims priority to German application no. DE 20 2004 001 679.6 filed on Feb. 4, 2004.

### FIELD OF THE DISCLOSURE

The disclosure relates to a tension or guide rail for a flexible drive means, in particular for a timing chain of an internal combustion engine, comprising a carrier body and a guide track which can be pressed onto the flexible driving means.

### BACKGROUND OF THE DISCLOSURE

Tension or guide rails are used in large quantities for internal combustion engines, in particular for timing drives. This field of use places high demands both on the strength of the rail and also on the sliding and guide properties in the contact region with the flexible drive means of the timing drive. Consequently, a lattice structure is often used with which the strength of the rail is improved by the struts of the lattice structure. Such carrier bodies are often manufactured as aluminium die-cast profile sections or as reinforced plastic profiles. As a consequence of the different requirements placed on such tension or guide rails, the guiding sections of the rails are usually made from a different material than that used for the carrier body. To form such a guide section with a guide track which comes into contact with the flexible drive means, normally a slideway liner is used which is permanently or detachably joined to the carrier body.

The striking competitive situation in the automotive industrial sector gives rise to a strong innovative pressure which, also in the field of internal combustion engines, drives on development and leads to ever shorter development cycles. In recent years internal combustion engines have become ever more complex with a rapidly increased quantity of auxiliary equipment and mutually networked components which has led to ever more complex engine designs with a noticeably increased number of functional elements and components, which must be accommodated within ever smaller installation spaces.

Although many tension or guide rails known in the state of the art have proven themselves in use, efforts are continuously being made due to the innovative pressure to improve designs and to adapt them to the increasing demands. Additionally, tension or guide rails are mass-produced products with which, with regard to the high quantities usual in the automotive industry, there is always the need to replace the designs used by more simple and economical concepts or by designs which lead to a simplification of the engine construction and therefore to a reduction of the assembly costs.

### SUMMARY OF THE DISCLOSURE

The problem of the disclosure is to provide a tension or guide rail of the type mentioned in the introduction, which fulfils the high demands for use in internal combustion engines, but which is also compatible with the increased complexity of modem engine design with a reduced engine installation space.

This problem is solved according to the disclosure in that the tension or guide rail comprises an installation channel which acts independently of the guide track.

From DE 37 06 136 C1 a rail with a channel enclosing a chain on all sides is known, where the carrier consists of two assembled parts. In this case the channel is only used for guiding the chain, whereby the slideway liner encloses the chain and forms the walls of the channel. Furthermore, tension or guide rails are known, for example, from DE 100 14 325 A1, which supply the guide track of the rail with lubricant using lubricant supply channels arranged in the base body to achieve the desired lubrication between the drive means and the guide track and to therefore achieve reduced wear. In contrast, with the embodiment of a tension or guide rail according to the disclosure presented here, an action-independent installation channel for supplementary purposes is provided beyond the original problem of the guidance and/or tensioning of a flexible drive means.

The above embodiment of the tension or guide rail according to the disclosure creates additional installation space in the internal combustion engine for the arrangement and guidance of engine components without negatively affecting the function or the strength of the rail, where the engine components are independent of the principal object of the rail. The installation channel facilitates the laying of cable harnesses or cables to sensors or actuators, the feedthrough of supply lines such as fluid pipes as well as flexible and rigid actuating means, or the feedthrough of other moving or removable components. The installation channel is primarily employed for introducing engine components that can function independently of the tension or guide rail. Through this installation channel, in addition to the guidance of the flexible drive means by the tension or guide rail in the rail, an installation space for the installation of additional engine components, which are functionally independent of the tension or guide rail, i.e. no guide track or flexible drive means, is facilitated.

An advantageous variant provides that the carrier body comprises at least a first and at least a second side part, which are permanently joined together and which jointly define the installation channel. When manufactured by the injection moulding technology, this embodiment of the tension or guide rail facilitates the use of simple moulds without a slide. Here, the carrier-body side parts are firmly joined together to prevent an unintentional release of the carrier-body side parts. The joint face arising due to the joining of the carrier-body side parts can extend preferably perpendicularly to the guide track and in the running direction of the flexible drive means. The carrier-body side parts forming the carrier body are preferably made from a fiber-reinforced plastic, normally a thermoplastic, using the injection molding technique, where other materials and manufacturing techniques, e.g. die-cast aluminium, are also possible. The carrier-body side parts can be firmly joined together preferably by glueing, for which an essentially undercut-free joint face is needed, welding, in particular ultrasonic welding, or by clipping with latching elements, either additional or integrated in the carrier-body side parts. Here, the carrier-body side-parts can preferably extend in the longitudinal direction of the tension or guide rail, so that also the installation channel runs in the longitudinal direction of the rail through the carrier body.

A favorable embodiment provides that the installation channel is formed enclosed on its circumferential surface. The enclosed formation of the installation channel facilitates an enclosing protection of the independent engine component arranged in the installation channel, as well as, particularly if the cross section is circular, a stable form of the installation channel and therefore also good strength properties of the tension or guide rail. In a stable design the width of the installation channel can correspond to over 50%, preferably over 80%, of the width of the carrier body.

For easy manufacture of the tension or guide rail, the walls of the installation channel can be formed by the carrier body. Consequently, additional cladding of the inner wall of the installation channel can be omitted.

Preferably, the installation channel can be formed with a first open end and with a second open end. This design of the installation channel facilitates the unhindered passage of engine components. Here, the open ends are preferably arranged at a distance from the guide track.

In an advantageous variant the first open end and the second open end are arranged on the faces of opposite ends of the tension or guide rail. In this way the installation channel can extend in the longitudinal direction through the carrier body, i.e. essentially in the running direction of the drive means.

Here, the installation channel can preferably run in the region of the lattice struts on the carrier body. The length of the installation channel can correspond to over 50%, preferably over 80%, of the length of the tension or guide rail, where the installation channel can run in a curved shape, preferably parallel to the guide track, in the carrier body.

A modification provides for the first open end and/or the second open end being formed with a protruding connection piece or for the acceptance of a connection piece. Such an embodiment of the installation channel facilitates a good connection to preceding or following installation and guidance units of the engine components arranged in the installation channel.

Apart from the arrangement on the faces of the open ends on the installation channel, at least one end can also be arranged on a side surface of a carrier-body side part pointing outwards and may present a connection piece. Here, this end of the installation channel can also be open towards both carrier-body side parts.

In an advantageous embodiment, the tension or guide rail comprises a slideway liner, which is joined to the carrier body and forms the guide track. The slideway liner facilitates good guiding and sliding properties of the guide track, independently of the carrier body and the material of the carrier body.

For a secure connection of the slideway liner to the carrier body, the slideway liner can be injection molded on at least one carrier-body side part. Such an injection molding of a slideway liner on a carrier-body side part normally occurs using a two-component molding method. With the carrier-body side parts which extend in the longitudinal direction and where the joint face essentially runs perpendicular to the guide track, the injection molding of the slideway liner on only one carrier-body side part requires a non-uniform distribution of the carrier body on the at least two carrier-body side parts if the slideway liner is to be injection molded over the complete width of the guide track.

A simple connection between the carrier body and a slideway liner can then be achieved in that the slideway liner is connected in a positive locking manner to the carrier body. In this case, first a separate slideway liner is produced which is later joined to the carrier body. Apart from the later installation on an assembled and tested carrier body, this also facilitates removal and replacement of the slideway liner.

Furthermore, the disclosure relates to an internal combustion engine with a timing drive comprising a flexible drive means and at least one tension or guide rail , where the flexible drive means is in contact with the guide track, and an additional component operating interactively with the internal combustion engine extends through the installation channel at least in some regions. Such an internal combustion engine facilitates a simplification of the design, in particular with complicated engine concepts with much auxiliary equipment and little installation space. The arrangement possibilities for additional components operating interactively with the internal combustion engine can be consequently-increased.

The disclosure could also relate to a method for the manufacture of a tension or guide rail for a flexible drive means, in particular a timing chain of an internal combustion engine, with a carrier body and a guide track which can be pressed onto the flexible drive means, whereby at least a first and at least a second carrier-body side part are manufactured, the carrier-body side parts are joined together and the carrier-body side parts jointly define an installation channel which is independent of any action of the guide track. This method facilitates the simple manufacture of tension or guide rails, which due to their design increase the arrangement possibilities for action-independent engine components, in particular in a restricted installation space for the internal combustion engine.

### BRIEF DESCRIPTION OF THE DRAWINGS

Based on the drawings, two embodiments of the tension or guide rail according to the disclosure are explained in more detail. The figures show:

FIG. 1 a perspective side view of a tension or guide rail,

FIG. 2 a perspective view of the joint face of a carrier-body side part of the tension or guide rail illustrated in FIG. 1,

FIG. 3 a perspective view of an outer side surface of a carrier-body side part of the tension or guide rail illustrated in FIG. 1, and

FIG. 4 a perspective side view of a further embodiment of a tension or guide rail.

### DETAILED DESCRIPTION OF THE DISCLOSURE

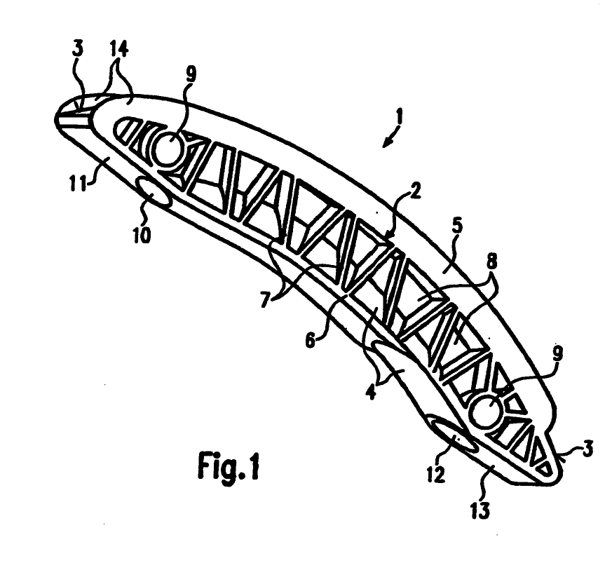

FIG. 1 shows a first embodiment of the tension or guide rail according to the disclosure, which comprises a carrier body 2 with a guide track 3 and an installation channel 4. The carrier body 2 presents an upper section 5 provided with the guide track 3 and a lower section 6, which are joined together by the lateral struts 7 to produce a lattice structure. The open areas of the lattice structure, which are defined by the upper section 5, the lower section 6 and the lateral struts 7, are interrupted by a partition wall 8. A bearing hole 9 is molded at both ends of the tension or guide rail 1 extending in the longitudinal direction. The installation channel 4 extends from a first opening 10 on a first face-side section 11 of the carrier body 2, which connects the upper section 5 to the lower section 6, to a second opening 12 on a second face-side section 13, which connects the upper section 5 to the lower section 6 at the opposite end of the carrier body 2 extending in the longitudinal direction. The first face-side section 11 and the second face-side section 13 run at an acute angle to the guide track 3 of the carrier body 2 to join the clearly shorter lower section 6 to the upper section 5. The installation channel 4 extends mainly through the lattice structure of the carrier body 2, where the wall of the installation channel 4 in some cases forms part of the partition wall 8. The guide track 3 on the upper section 5 of the carrier body 2 presents two side guides 14 extending in the longitudinal direction, which protrude with respect to the guide track 3 and are formed together with the carrier body 2, and form a side guide for the flexible drive means.

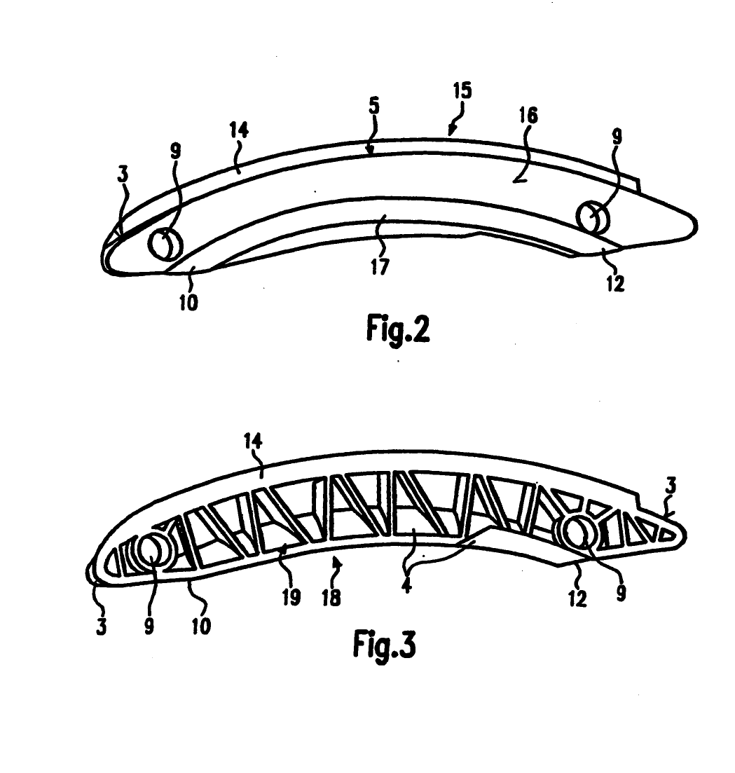

FIG. 2 shows the perspective view of a first carrier-body side part 15 with a view on the joint face 16, with which the first carrier-body side part 15 can be joined to a second carrier-body side part. In the joint face 16 the installation channel 4 runs below the bearing holes 9 as a semi-circular recess, which is curved in the longitudinal direction, between the first opening 10 and the second opening 12, and which forms the inner wall 17 of the installation channel 4. In the upper section of the first carrier-body side part 15 a side guide 14 and a part of the guide track 3 are formed.

FIG. 3 shows a second carrier-body side part 18 of the tension or guide rail 1 shown in FIG. 1 with its outer side surface 19 which can be joined to the first carrier-body side part 15 shown in FIG. 2 to form the tension or guide rail 1 according to the disclosure shown in FIG. 1.

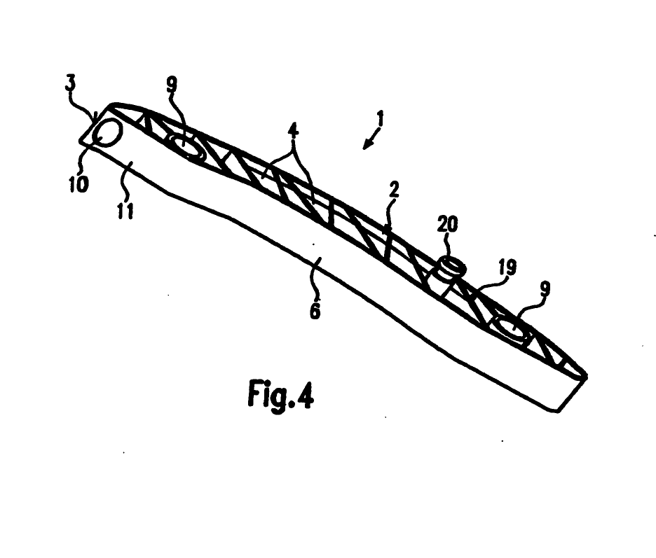

A further embodiment of the tension or guide rail 1 according to the disclosure is illustrated in FIG. 4. With regard to the carrier body 2 and the formation of the guide track 3, this tension or guide rail 1 presents a design which is identical to the embodiment shown in FIG. 1, which is why reference is made to the above description for the carrier body 2 and the guide track 3, and in the following only the differences compared to the design illustrated first are explained. The installation channel 4 of this tension or guide rail 1 extends from a first opening 10 arranged directly adjacent to the guide track 3 on the first face-side section 11 through the carrier body 2 up to a connection piece 20 protruding from the outer side surface 19 of the carrier-body side part in the vicinity of the second bearing hole 9.

The carrier body 2 of this tension or guide rail 1 according to the disclosure preferably consists of plastic, e.g. a fiber-reinforced thermoplastic material, where the upper section 5 of the carrier body 2 forms an even guide track 3 running curved in this embodiment. Here, the carrier body 2 is normally manufactured as a single part in one working process, preferably in an injection molding process, whereby the installation channel 4 forms directly during the injection molding process through a slide introduced into the respective injection molding tool. Alternatively, the first carrier-body side part 15 and the second carrier-body side part 18 can be manufactured independently of one another and permanently joined together in a second working step. Apart from simply glueing the joint faces 16 of the carrier-body side parts 15 and 18 together, welding, in particular ultrasonic welding, and joining using positive locking elements, e.g. latching elements, are possible.

To improve the sliding and guiding properties of the guide track 3, the carrier body 2 can be provided with a slideway liner. Apart from being fitted later to the finished carrier body 2, such a slideway liner can be fitted to a carrier-body side part 15, 18 before the joining of the carrier-body side parts 15 and 18 using a two-component injection technique. To avoid seams and interruptions, with a two-part formation of the carrier body 2, such a slideway liner can be preferably joined to only one carrier-body side part, whereby the carrier-body side parts 15 and 18 in the region of the upper section 5 of the carrier body 2 must be formed differently, i.e. the guide track 3 is formed by only one carrier-body side part 15, 18.

1. Tension or guide rail for a flexible drive means with a carrier body and a guide track which can be pressed onto the flexible drive means, comprising an installation channel which acts independently from the guide track and formed as a circumferential surface, and the walls of the installation channel are formed by the carrier body.

2. Tension or guide rail according to claim 1, wherein the carrier body comprises at least a first and at least a second carrier-body side part, the carrier-body side parts being joined together and jointly define the installation channel.

3. Tension or guide rail according to s claim 1, wherein the installation channel is formed with a first open end and a second open end.

4. Tension or guide rail according to claim 3, wherein the first open end and the second open end are arranged on opposite face-side ends of the tension or guide rail.

5. Tension or guide rail according to claim 3, wherein the first open end the second open end, or both the first and second open end is formed with one of a protruding connection piece and for accepting a connection piece.

6. Tension or guide rail according to claim 1, wherein the tension or guide rail comprises a slideway liner which is joined to the carrier body and forms the guide track.

7. Tension or guide rail according to claim 6, wherein the slideway liner is injected onto at least one carrier-body side part.

8. Tension or guide rail according to claim 6, wherein the slideway liner is joined to the carrier body in a positive locking manner.

9. Timing chain drive for an internal combustion engine, comprising a timing chain and at least one tension or guide rail having a carrier body and a guide track pressed onto the timing chain, the tension or guide rail having an installation channel which acts independently from the guide track and which is formed enclosed on its a circumferential surface, and the walls of the installation channel are formed by the carrier body.

10. Internal combustion engine having a timing drive comprising a flexible drive means and at least one tension or guide rail according to claim 1, wherein the flexible drive means is in contact with the guide track and an additional component interacting with the internal combustion engine extends through the installation channel at least in some sections.

11. Internal combustion engine having a timing chain drive, comprising a timing chain and at least one tension or guide rail having a carrier body and a guide track pressed onto the timing chain, the tension or guide rail having an installation channel which acts independently from the guide track and which is formed enclosed on its circumferential surface, the walls of the installation channel being formed by the carrier body, an additional component interacting with the internal combustion engine, and at least some sections of the additional component extending through the installation channel.
